(19) United States
(12) Patent Application Publication
(10) Pub. No.: US 2007/0295183 A1
(43) Pub. Date: Dec. 27, 2007

(54) Feedback systems for adjustment mechanisms on power tools

(76) Inventors: Robert P. Welsh, Phoenix, MD (US); Mehul R. Jani, Towson, MD (US)

Correspondence Address: Mehul R. Jani;Black & Decker Corporation, Mail Stop TW199, 701 E. Joppa Rd, Towson, MD, 21286, US

(21) Appl. No.: 11/474,763

(22) Filed: Jun. 26, 2006

(51) Int. Cl. B27B 27/04

(52) U.S. Cl. 83/477.2

(57) ABSTRACT

The present invention relates to feedback systems that are used with power tools to provide the user with sensory feedback information allowing the user to determine the position of an adjustable portion of a power tool with respect to a stationary portion of a power tool or with respect to a workpiece without having to refer to a scale or manual measuring device. This feedback information may make it easier and faster for the user to determine the orientation or location of an adjustable portion of a power tool or determine the orientation or location of the workpiece with respect to an operational member of the power tool allowing the user to concentrate his thinking on executing the operation instead of concentrating on set up.

### FIELD

The present disclosure relates to power tools, and more particularly to feedback systems for adjustment mechanisms found on power tools.

### BACKGROUND AND SUMMARY OF THE INVENTION

The statements in this section merely provide background information related to the present disclosure and may not constitute prior art.

Many power tools, both portable and stationary, include adjustment mechanisms to assist the user adjusting the operational member of a power tool or in aligning the workpiece with the operational member of the power tool. For example, table saws include fences to help the user align the workpiece with the saw blade so that the workpiece can be cut at the desired location. Another example is the cutterhead adjustment handle on a planer. The cutterhead adjustment handle is used to lower the planer head to the desired height to perform the planing operation on the workpiece.

Traditionally, users look at scales or similar measuring implements provided on the power tool to determine the position of an operational member or to determine the position of the workpiece with respect to the operational member of the power tool. Alternatively, users may simply measure the workpiece with respect to operational member of the power tool using a manual measuring device such as measuring tape.

The present disclosure provides feedback systems that are used with power tools to provide the user with sensory feedback information allowing the user to determine the position of an adjustable portion of a power tool with respect to a stationary portion of a power tool or with respect to a workpiece without having to refer to a scale or manual measuring device. This makes it very easy and fast for the user to determine the orientation or location of an adjustable portion of a power tool or determine the orientation or location of the workpiece with respect to an operational member of the power tool allowing the user to concentrate his thinking on executing the operation instead of concentrating on set up.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a planer including a feedback system according to the principles of the present disclosure;

FIG. 2 is a perspective view of a table saw including a feedback system according to the principles of the present disclosure;

FIG. 3 is a perspective view of a drill press including a feedback system according to the principles of the present disclosure;

FIG. 4 is a cross-sectional view of a portion of any one of the power tools shown in FIGS. 1-3 detailing a feedback system according to the principles of the present disclosure;

FIG. 5 is a cross-sectional view of a portion of any one of the power tools shown in FIGS. 1-3 detailing a feedback system according to the principles of the present disclosure;

FIG. 6 is a cross-sectional view of a portion of any one of the power tools shown in FIGS. 1-3 detailing a feedback system according to the principles of the present disclosure;

### DETAILED DESCRIPTION OF THE PREFERRED EMBODIMENTS

The following description is merely exemplary in nature and is not intended to limit the present disclosure, application, or uses. It should be understood that throughout the drawings, corresponding reference numerals indicate like or corresponding parts and features.

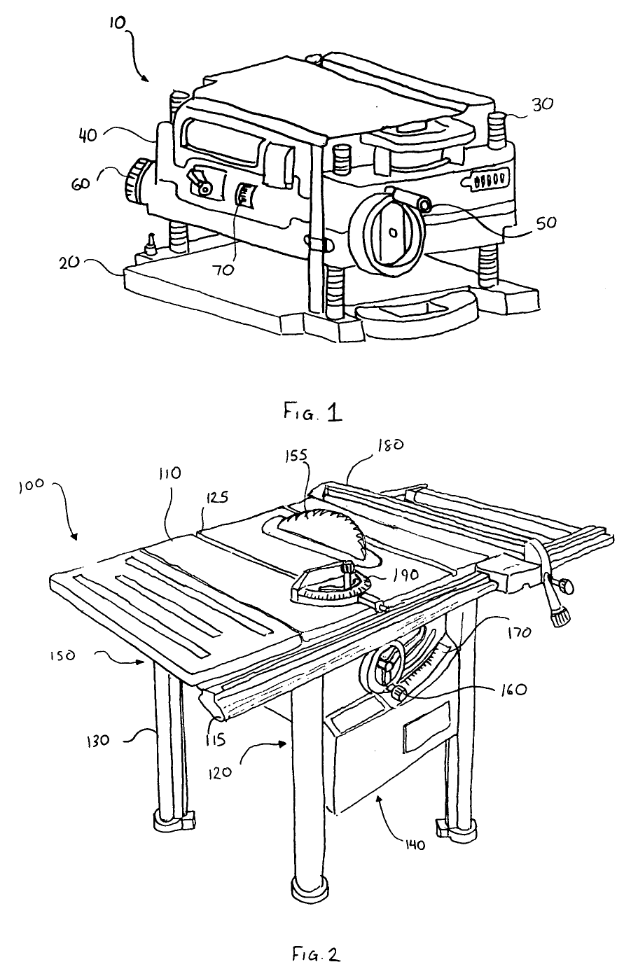

With reference to FIG. 1, an exemplary planer mechanism constructed in accordance with the teachings of the present invention is generally indicated by reference numeral 10. Planer mechanism 10 may include a base assembly 20, at least two (and preferably four) support columns 30, and a carriage assembly 40 mounted unto the support columns 30. Carriage assembly 40 may carry a motor, a cutterhead driven by the motor and/or feed rollers driven by the motor, as is well known in the art.

Persons skilled in the art will recognize that carriage assembly 40 may threadably engage support columns 30. Persons skilled in the art are directed to U.S. Pat. No. 6,601,621, which is incorporated herein by reference, for further information on how the carriage assembly 40 is mounted unto the support columns 30 to allow adjustment of the distance between carriage assembly 40 and base assembly 20. Nonetheless, persons skilled in the art will recognize that base assembly 20 may be movably mounted unto support columns 30 to allow adjustment of the distance between carriage assembly 40 and base assembly 20.

Adjustment of carriage assembly 40 relative to the base assembly 20 is accomplished by the user rotating handle assembly 50. Traditionally, the user would use cutterhead height adjustment knob 60 and scale 70 to determine the distance carriage assembly 40 has traveled and the relative distance between the cutterhead (not shown) and the workpiece (not shown). However, as discussed below, the present invention preferably provides a sensory feedback system that can be used, for example, to replace the need for referring to scales or adjustment knobs or to augment the use of scales or knobs to determine the distance carriage assembly 40 has traveled and the relative distance between the cutterhead and the workpiece. Although only the example of the carriage assembly 40 is discussed, persons skilled in the art will recognize that the sensory feedback systems can be used with any adjustment mechanisms in the planer 10.

Turning to FIG. 2, an exemplary table saw mechanism constructed in accordance with the teachings of the present invention is generally indicated by reference numeral 100. Exemplary table saw 100 may have a table 110 including tracks 115 and 125 for receiving fences, a base assembly 120, including legs 130, supporting the table 110, and a front panel 140 connected to the base assembly 120, legs 130 and/or table 110. A saw assembly 150 may be pivotally attached underneath the table 110. Saw assembly 150 carries a rotatable cutting tool, such as blade 155. Saw assembly 150 may include a cradle (not shown).

As part of the adjustment mechanisms employed by exemplary table saw 100, the angle of blade relative to table 110 may be changed. In a preferred embodiment, the cradle may be provided with a bevel sector gear (not shown) thereon. The bevel sector gear has a rack (not shown) which meshes with a worm drive (not shown) disposed on bevel shaft (not shown), which is rotated via bevel crank wheel 160. When bevel crank wheel 160 is rotated, the bevel shaft and its worm drive rotate. The worm drive meshes with the rack, causing the cradle and blade 155 to rotate, thus changing the bevel angle of blade 155 relative to table 110. For further discussion of the bevel angle adjustment mechanism, persons skilled in the art are directed to U.S. Pat. No. 6,530,303, which is incorporated herein by reference.

Customarily, the user would use scale 170 to determine the bevel angle of blade 155 relative to table 110. However, as discussed below, the present invention preferably provides a sensory feedback system that can be used, for example, to replace the need for referring to scales or to augment the use of scales to determine the bevel angle of blade 155. Although only the example of the blade 155 bevel angle is discussed, persons skilled in the art will recognize that the sensory feedback systems can be used with any adjustment mechanisms in the table saw 100, including those, for example, that permit adjustments to the height of blade 155 with respect to table 110 and those that permit adjustments to fences 180 and 190 on table 110 of table saw 100.

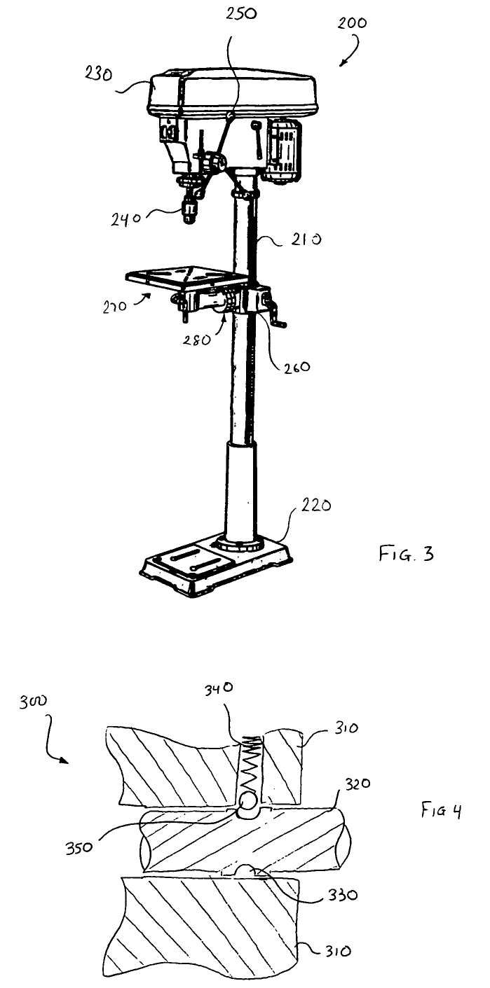

Referring to FIG. 3, an exemplary drill press mechanism constructed in accordance with the teachings of the present invention is generally indicated by reference numeral 200. Drill press 200 preferably includes main column 210, base 220 and head 230. Column 210 preferably has a hollow cylindrical shape and fits within an opening formed in base 220 and is supported by base 220 to extend substantially vertically. Head 230 preferably includes an opening which receives column 210 and is supported thereby. A chuck 240 and rotatable handle 250 for raising or lowering the chuck 240 preferably extend from head 230. In addition, in a preferred embodiment, a drive mechanism for the chuck 240 is disposed within head 230.

The exemplary embodiment of drill press 200 also preferably includes cylindrical casting 260 disposed about column 210. Cylindrical casting 260 provides an interface between worktable assembly 270 and column 210 of drill press 200. In a preferred embodiment, cylindrical casting 260 may translate vertically along column 210 or may rotate about column 210 allowing worktable assembly 270 to translate or rotate about column 210. In addition, cylindrical casting 260 provides a mechanism 280 to allow the user to rotate worktable assembly 270 with respect to column 210.

Conventionally, the user would use a scale preferably located on cylindrical casting 260 to determine the angle of worktable 270 relative to column 210. However, as discussed below, the present invention preferably provides a sensory feedback system that can be used, for example, to replace the need for referring to scales or to augment the use of scales to determine the angle of worktable 270. Although only the example of the adjustments to worktable 270 is discussed, persons skilled in the art will recognize that the sensory feedback systems can be used with any adjustment mechanisms in the drill press 200, including, for example, those that permit adjustments to the chuck 240 with respect to the worktable 270.

Turning to FIGS. 4-6, several exemplary feedback mechanisms are shown. Each of these exemplary feedback mechanisms can be used with any adjustment mechanism found on a power tool, including those that were just discussed.

With reference to FIG. 4, a first preferred feedback system 300 is shown. As discussed above, feedback system 300 can be used with a power tool adjustment mechanism. Feedback system 300 preferably includes a stationary portion 310. Stationary portion 310 may be any portion of a power tool that receives a portion of a power tool adjustment mechanism. For example, looking at the above discussed power tools, carriage assembly 40 of planer 10 may include stationary potion 310, front panel 140 of table saw 100 may include stationary portion 310, and cylindrical casting 260 of drill press 200 may include stationary portion 310.

Feedback system 300 also preferably includes an actuation portion 320 having at least one notch 330, but preferably a plurality of notches 330. In a preferred embodiment, notches 330 are formed such that they are located at a predetermined distance from each other. Actuation portion 320 may be any portion of the power tool adjustment mechanism that couples to a power tool adjustment mechanism user interface. For example, looking at the above discussed power tools, rotating handle assembly 50 of planer 10 may couple with actuation portion 320, bevel crank wheel 160 of table saw 100 may couple with actuation portion 320, and adjustment mechanism 280 of drill press 200 may couple with actuation portion potion 320.

In a preferred embodiment, feedback system 300 also includes at least one biasing member 340 and at least one detent member 350. Biasing member 340 preferably is coupled with stationary portion 310 at one end and coupled with detent member 350 at the other end. Detent member 350 preferably is configured and dimensioned to engage notches 330 on actuation portion 320. In another preferred embodiment, notches 330 could be located on stationary portion 310 and detent member 350 and biasing member 340 could be located on actuation portion 320.

In an exemplary use, when the user manipulates the power tool adjustment mechanism, for example, rotating handle assembly 50 of planer 10, rotating bevel crank wheel 160 of table saw 100, or rotating adjustment mechanism 280 of drill press 200, actuation portion 320 of feedback system 300 is actuated. In a preferred embodiment, when actuated, actuation portion 320 rotates with respect to stationary portion 310 allowing detent member 350 to engage and disengage from notches 330. More specifically, detent member 350, which in a preferred embodiment is a ball detent, is biased towards actuation portion 350 by biasing portion 340, which in a preferred embodiment is a spring. As actuation portion 320 rotates, detent member 350 abuts an outer surface of actuation portion 320 until engaging one of the notches 330. As actuation portion 320 continues to rotate, detent member 350 will disengage from notch 330 and again abut the outer surface of actuation portion 320 until the next notch 330. The engagement and disengagement of detent member 350 with notch 330 will provide the user with tactile and audible feedback. Additionally, since the notches 330 are placed at predetermined locations, each engagement and disengagement of detent member 350 with notch 330 can be tied to a certain amount of adjustment of the power tool adjustment mechanism thereby indicating to the user how much adjustment has been done without the need to refer to a scale. For example, each engagement and disengagement of detent member 350 with notch 330 can indicate 0.X degree of beveling of blade 155 on table saw 100.

In another preferred embodiment, the depth of notches 330 can be varied giving the user additional tactile and audible feedback. For example, if there are four notches 330 on actuation portion 320, one notch 330 may be larger than the other notches, so when detent member 350 engages and disengages the larger notch 330, that can indicate something in addition to what the remaining notches 330 indicate. Turning back to the table saw 100 example, the larger notch 330 feedback could indicate X degree of beveling of blade 155 on table saw 100 while the remaining notches 330 could indicate 0.X degree of beveling.

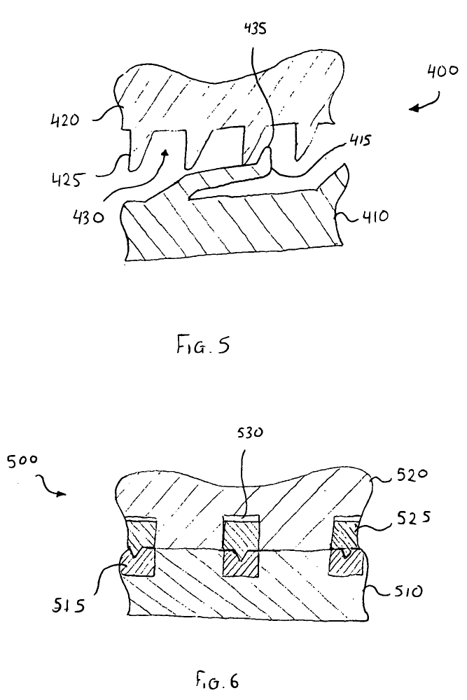

Turning to FIG. 5, a second preferred feedback system 400 is shown. As discussed above, feedback system 400 can be used with a power tool adjustment mechanism. Feedback system 400 preferably includes a stationary portion 410 having at least one, but preferably a plurality of biasing arms 415 that are configured and dimensioned to engage a plurality of engagement members 425, discussed below. Stationary portion 410 may be any portion of a power tool that operationally engages a portion of a power tool adjustment mechanism. For example, looking at the above discussed power tools, carriage assembly 40 of planer 10 may include stationary potion 410, track 115 of table saw 100 may include stationary portion 410, and cylindrical casting 260 of drill press 200 may include stationary portion 410.

Feedback system 400 also preferably includes an actuation portion 420 having a plurality of engagement members 425. In a preferred embodiment, engagement members 425 are formed such that they are located at a predetermined distance from each other. Actuation portion 420 may be any portion of the power tool adjustment mechanism that couples to a power tool adjustment mechanism user interface. For example, looking at the above discussed power tools, rotating handle assembly 50 of planer 10 may couple with actuation portion 420, Fences 180 or 190 of table saw 100 may couple with actuation portion 420, and adjustment mechanism 280 of drill press 200 may couple with actuation portion potion 420. In another preferred embodiment, stationary portion 410 may include engagement members 425 and actuation portion 420 may include biasing arms 425.

In an exemplary use, when the user manipulates the power tool adjustment mechanism, for example, rotating handle assembly 50 of planer 10, sliding fence 180 on table 110 of table saw 100, or rotating adjustment mechanism 280 of drill press 200, actuation portion 420 of feedback system 400 is actuated. In a preferred embodiment, when actuated, actuation portion 420 moves with respect to stationary portion 410 allowing biasing arms 415 to engage and disengage engagement members 425. As actuation portion 420 moves, biasing arms 415 also move and continue to abut engagement members 425 until tips 435 of biasing arms 415 abut engagement members 425. Continued movement of actuation portion 420 after this point results in biasing arms 415 disengaging from engagement members 425 and moving into recesses 430 until continued movement re-engages biasing arms 415 with engagement members 425. The engagement and disengagement of biasing arms 415 with engagement members 425 will provide the user with tactile and audible feedback. Additionally, since the engagement members 425 are placed at predetermined locations, each engagement and disengagement of biasing arms 415 with engagement members 425 can be tied to a certain amount of adjustment of the power tool adjustment mechanism thereby indicating to the user how much adjustment has been done without the need to refer to a scale. For example, each engagement and disengagement biasing arms 415 with engagement members 425 can indicate X.X inches of movement of fence 180 on table saw 100.

Turning to FIG. 6, a third preferred feedback system 500 is shown. As discussed above, feedback system 500 can be used with a power tool adjustment mechanism. Feedback system 500 preferably includes a stationary portion 510 having at least one, but preferably a plurality of grooves 515. In a preferred embodiment, grooves 515 are formed such that they are located at a predetermined distance from each other. Stationary portion 510 may be any portion of a power tool that operationally engages a portion of a power tool adjustment mechanism. For example, looking at the above discussed power tools, carriage assembly 40 of planer 10 may include stationary potion 510, track 115 of table saw 100 may include stationary portion 510, and cylindrical casting 260 of drill press 200 may include stationary portion 510.

Feedback system 500 also preferably includes an actuation portion 520 having at least one, but preferably a plurality of detent members 525. Detent members 525 are preferably located in cavities 530, which are longer than the length of detent members 525 thereby allowing detent members 525 to translate within the cavities 530. In a preferred embodiment, detent members 525 preferably are configured and dimensioned to engage grooves 515 on stationary portion 510. In another preferred embodiment, grooves 515 could be located on actuation portion 510 and detent member 525 could be located on stationary portion 510.

In an exemplary use, when the user manipulates the power tool adjustment mechanism, for example, rotating handle assembly 50 of planer 10, moving fence 180 of table saw 100, or rotating adjustment mechanism 280 of drill press 200, actuation portion 520 of feedback system 500 is actuated. In a preferred embodiment, when actuated, actuation portion 520 moves with respect to stationary portion 510 allowing detent member 525 to engage and disengage from grooves 515. More specifically, as actuation portion 520 is moved, detent members 525 abut an outer surface of stationary portion 510 until engaging one of the grooves 515. As actuation portion 520 continues to move, detent members 525 will disengage from grooves 515 and again abut the outer surface of stationary portion 510 until the next groove 515. The engagement and disengagement of detent members 525 with grooves 515 will provide the user with tactile and audible feedback. Additionally, since the grooves 515 are placed at predetermined locations, each engagement and disengagement of detent members 525 with grooves 515 can be tied to a certain amount of adjustment of the power tool adjustment mechanism thereby indicating to the user how much adjustment has been done without the need to refer to a scale. For example, each engagement and disengagement of detent member 525 with grooves 515 can indicate X.X inches of movement of fence 180 on table saw 100.

The description of the invention is merely exemplary in nature and, thus, variations that do not depart from the spirit of the invention are intended to be within the scope of the invention. Such variations are not to be regarded as a departure from the spirit and scope of the invention. Furthermore, although only select power tools were described with respect to the present invention, it should be understood that the present invention is applicable to any power tool that includes an adjustment mechanism.

What is claimed is:

1. A feedback system for a power tool, comprising:
a stationary portion located on the power tool having at least one cavity at a predetermined location to receive at least one detent mechanism;
an actuation portion engageable with the stationary portion and coupled to an adjustment mechanism on the power tool, the actuation portion having at least one groove for engagement with the at least one detent mechanism,
wherein actuation of the adjustment mechanism of the power tool by a user results in movement of the actuation portion with respect to the stationary portion, engaging and disengaging the at least one detent mechanism from the at least one groove creating either or both audible and tactile feedback for the user of the power tool.

2. The feedback mechanism of claim 1, wherein the predetermined location of the groove corresponds to an incremental movement of the power tool adjustment mechanism.

3. The feedback system of claim 1, further comprising at least one biasing mechanism for biasing the at least one detent mechanism toward the at least one groove.

4. The feedback system of claim 3, wherein the biasing mechanism is a spring.

5. The feedback system of claim 1, wherein the detent mechanism is a ball detent.

6. The feedback system of claim 5, wherein the groove is substantially hemi-spherical.

7. The feedback system of claim 1, comprising a plurality of grooves each located at a predetermined location and having differing groove depths to provide varying feedback to the user.

8. The feedback mechanism of claim 1, wherein the power tool is a planer.

9. The feedback mechanism of claim 1, wherein the power tool is a table saw.

10. The feedback mechanism of claim 1, wherein the power tool is a drill press.

11. The feedback mechanism of claim 1, comprising a plurality of detent mechanisms received in a plurality of cavities and a plurality of grooves.

12. The feedback mechanism of claim 11, wherein the cavities are configured and dimensioned to be larger than the detent mechanism to translatably receive the detent mechanisms.

13. The feedback mechanism of claim 1, wherein the detent mechanism includes a portion having a substantially conical shape for engagement with the groove.

14. The feedback mechanism of claim 13, wherein the groove is substantially conical.

15. A feedback system for a power tool, comprising:
a stationary portion located on the power tool having at least one groove at a predetermined location;
an actuation portion engageable with the stationary portion and coupled to an adjustment mechanism on the power tool, the actuation portion having at least one cavity to receive at least one detent mechanism for engagement with the at least one groove,
wherein actuation of the adjustment mechanism of the power tool by a user results in movement of the actuation portion with respect to the stationary portion, engaging and disengaging the at least one detent mechanism from the at least one groove creating either or both audible and tactile feedback for the user of the power tool.

16. The feedback mechanism of claim 15, wherein the predetermined location of the groove corresponds to an incremental movement of the power tool adjustment mechanism.

17. A feedback system for a power tool, comprising:
a stationary portion located on the power tool having at least one biasing member extending therefrom;
an actuation portion engageable with the stationary portion and coupled to an adjustment mechanism on the power tool, the actuation portion having at least one engagement member at a predetermined location for engagement with the at least one biasing member,
wherein actuation of the adjustment mechanism of the power tool by a user results in movement of the actuation portion with respect to the stationary portion, engaging and disengaging the at least one biasing member from the at least one engagement member creating either or both audible and tactile feedback for the user of the power tool.

18. The feedback mechanism of claim 17, wherein the predetermined location of the engagement member corresponds to an incremental movement of the power tool adjustment mechanism.

19. The feedback mechanism of claim 17, wherein the biasing member is a spring biased arm having a tip extending outwardly therefrom for engagement with the engagement members.

20. The feedback mechanism of claim 17, wherein the power tool is a planer.

21. The feedback mechanism of claim 17, wherein the power tool is a table saw.

22. The feedback mechanism of claim 17, wherein the power tool is a drill press.

23. A feedback system for a power tool, comprising:
a stationary portion located on the power tool having at least one engagement member at a predetermined location;
an actuation portion engageable with the stationary portion and coupled to an adjustment mechanism on the power tool, the actuation portion having at least one biasing member extending therefrom for engagement with the at least one engagement mechanism,
wherein actuation of the adjustment mechanism of the power tool by a user results in movement of the actuation portion with respect to the stationary portion, engaging and disengaging the at least one biasing member from the at least one engagement member creating either or both audible and tactile feedback for the user of the power tool.

24. The feedback mechanism of claim 23, wherein the predetermined location of the engagement member corresponds to an incremental movement of the power tool adjustment mechanism.
